(19) United States
(12) Patent Application Publication
(10) Pub. No.: US 2005/0250443 A1
(43) Pub. Date: Nov. 10, 2005

(54) Method and device for the exchange of information

(76) Inventors: Konrad Rutten, Heinsberg (DE); Markus Schneider, Alsdorf (DE)

Correspondence Address: CANTOR COLBURN, LLP, 55 GRIFFIN ROAD SOUTH, BLOOMFIELD, CT, 06002, US

(21) Appl. No.: 10/667,276

(22) Filed: Sep. 19, 2003

(30) Foreign Application Priority Data
Sep. 23, 2002 (EP) 02021092.8

(51) Int. Cl. H04B 1/38; H04B 1/40

(52) U.S. Cl. 455/41.2; 455/84; 455/73

(57) ABSTRACT

The disclosure concerns a method and a process for exchanging information between a central information unit on the one hand and a person and/or an object on the other hand. In order to enable a rapid exchange of information that is simple to implement, and moreover to furnish a method that can be cost-effectively and easily incorporated into already existing communications systems, a method includes transmitting an identification signal via short-range radio from a radio module to a receiver unit and from there to the information unit, wherein the information unit processes said identification signal and generates an output signal, which is then transferred to a corresponding output unit.

The invention concerns a method and a device for exchanging information between a central information unit on the one hand and a person and/or an object on the other.

Methods of the aforementioned type are known from the state of the art in numerous forms, and have proven themselves in practical use. One form mentioned by way of example is the exchange of information between a central information unit and a person seeking access to a secured access area or seeking to obtain information on this area.

Using appropriate means of identification in order to grant persons and/or objects, and under certain circumstances only specific persons and/or objects, access to a secured access area is known from the state of the art. Hence, for example, magnetic cards that store all data necessary for an identification are known from the state of the art. These data can be read out and interpreted by a card-reading unit. In this way it can be assured that only actually authorized persons and/or objects will receive access to a secured area.

Examples of applications for the use of magnetic cards as a means of authorization or identification include closing and opening systems for doors and gates as well as barriers, for example in parking lots and parking garages.

With these systems, persons or objects authorized for a reason receive a magnetic card provided with an access code. For actual entry into the secured access area, for example a parking garage, the card is inserted into a corresponding reading device. As soon as this is done and a positive authorization is recognized by the card-reading device, the door, or the barrier in the example of a parking garage, opens. Following entry into the secured access area, the door or barrier is again closed to those not authorized to enter. In order then to be able to exit the secured access area, the magnetic card is inserted in the same manner into a corresponding reading unit, whereupon the access is reapproved. This system has proven advantageous, among other things, for regular customers or those using long-term parking in parking lots and parking garages.

The disadvantage of the above-described system, however, is the in part lengthy and under certain circumstances expensive handling of the magnetic cards. For one, a certain amount of time is required to get the magnetic card ready, to introduce it into the card-reading device, and to wait for processing by the card-reading unit until the door or barrier opens. When this system is used in parking lots or parking garages, this time requirement, in combination with the time required to move up to the barrier and open the barrier, can be so long that long waiting lines form in front of parking lots and parking garages.

Further disadvantages of the magnetic card system, which apply to more than just the previously described application, are based upon the fact that, due to the positioning of the magnetic strip, the magnetic card must be inserted into a corresponding card-reading device in the proper alignment in order to allow the data stored on it to be read out. If the card is introduced into the card-reading device with an improper alignment of the magnetic strip, i.e. turned 180° around either the longitudinal or the transverse axis, the cards [sic] stored on the magnetic strip cannot be read in, consequently access to the secured access area will be denied. Only when the user recognizes the proper card alignment can the card-reading device successfully read the magnetic strip on the magnetic card.

The object of the present invention is therefore to disclose a method for exchanging information between a central information unit on the one hand and a person and/or an object on the other hand, which will enable a simple and rapid exchange of information that is easy to implement and can be easily and cost-effectively incorporated into already existing communications systems.

Moreover, a device for implementing the method is to be proposed with the invention.

In relation to the method, the invention will propose a method for exchanging information between a central information unit on the one hand and a person and/or an object on the other in which an identification signal is transmitted via short-range radio from a radio module to a receiving unit and from there to the information unit, wherein the information unit processes the identification signal and generates an output signal, which is then transferred to a corresponding output unit.

The particular advantage of the method specified in the invention is founded in the use of short-range radio. A substantially simpler and more rapid exchange of information is attained herewith, since it is no longer necessary to use additional auxiliaries such as magnetic cards and magnetic card-reading devices.

For the successfully implementation of the method, an identification signal must first be sent by the person and/or the object. This is accomplished via a radio module. The identification signal is received by a receiving unit, which transmits said signal to an information unit. The identification signal is unique and unambiguous, so that a clear allocation can be effected using this identification signal. The identification signal transmitted to the information unit is processed by the latter resulting in the generation of an output signal, which is then transferred to a corresponding output unit.

A transmission unit, or as an alternative to this a signal processing unit, can be provided as an output unit. The difference between a transmission unit and a signal processing unit here consists in the manner in which the output signal generated by the information unit is offered to the person and/or object. The transmission unit preferably serves to mediate information, i.e., the output signal generated by the information unit is transferred via the transmission unit to the radio module as information perceivable by the person and/or the object. For example, the radio module can be provided with a data display unit, such as a screen, via which a visual information exchange is made possible. It is also conceivable for the radio module to have available a loudspeaker so that an acoustic exchange can take place. One application example for such a method of information exchange would involve searching for a parking spot in a parking garage or in a parking lot. The person seeking the parking spot could contact the central information unit of the parking lot or the parking garage via his/her radio module before entering the parking lot or parking garage. This unit would then transmit information as to whether the parking lot or parking garage still had free parking spaces available, and if necessary could provide directions to a free parking space.

According to an alternative configuration, a signal processing unit is used as the output unit for the output signal generated by the information unit. As distinct from the previously described transmission unit, the signal processing unit transmits no information to be perceived visually or acoustically by the person and/or the object, but rather converts the transmitted output signal into a defined work instruction and implements the latter. One practical example of this would be the restriction of parking lots or parking garages. A person seeking a parking space drives up to the barrier of the parking garage or the parking lot and transmits a corresponding identification signal via his/her radio signal. This is processed by the information unit and interpreted to mean that the person seeking a parking space seeks access to the parking garage or the parking lot. Thereupon the access barrier of the parking lot or the parking garage is actuated by the information unit through the output signal generated by it, and the parking barrier opens so that the person seeking a parking space receives access to the parking lot or the parking garage.

In addition to the identification signal, the person and/or the object can also transmit an additional inquiry signal to the information unit. Such an inquiry signal could be an inquiry as to the rate systems in force or the like; hence a person searching for a parking space via his/her radio module can attain three things. First, the barrier to the parking lot or the parking garage opens and the person seeking a parking space consequently receives entry. Second, information is transmitted to him/her concerning the nearest free parking space. And third, he/she can obtain information as to the rate structure of the parking lot or the parking garage.

Consequently, with the method disclosed in the invention a method for the exchange of information is proposed that can be implemented very simply and that will enable a rapid supplying of information or a rapid exchange of information.

According to one particularly advantageous proposal of the method, a method for exchanging information, especially for identifying a person and/or an object for access to a secured access area is provided, wherein an information signal is transmitted from a radio module via short-range radio to a stationary receiving unit positioned in the access area, and is then transferred to the information unit. The information unit checks the transmitted information signal and upon a successful test approves access.

In this, an examination of the transmitted information signal is implemented, based upon a comparison test between an identification previously stored by the information unit and the transmitted information signal, wherein access is approved if identity exists between the transmitted information signal and the stored identification. To this end, first an identification must be generated for each person and/or each object to be authorized for successful implementation of the method. This identification is then stored in the information unit, which is designed, for example, as a central computer unit. The identification is unique and unambiguous so that a positive individual allocation can take place via this code. In this, it can be provided that either the identification is established during an initial registration or, alternatively, the identification is automatically established during the initial use, i.e. when the method is first implemented. With this alternative variant, a registration of the person and/or the object takes place at the moment in which he/she makes use of the method for the first time and the system receives the identification signal transmitted via his/her radio module.

Every person and/or object identified is provided with a radio module, which transmits the individually issued identification to a stationary receiving unit positioned in the access area when access to the secured access area is sought. This transmission process can advantageously take place automatically as soon as the radio module is located in the area of the receiver unit, whereby, for example, an area in the vicinity of 10 m around the receiver unit can be selected.

After receiving the identification signal, the receiver unit transmits the signal to the information unit. This unit then checks the identification signal transmitted by the receiver unit against the previously stored identification in a comparison test. If the transmitted identification signal and the stored identification signal are identical, access to the secured access area is granted by the information unit.

With the proposed method, as distinct from state-of-the-art methods, a time-optimized access to the secured access area can be advantageously realized. Unnecessary waiting lines can consequently be avoided.

The aforementioned method is especially well suited for use at entrances and exits of parking lots and parking garages, since thenceforth drivers provided with identification need only drive with their radio module into the area around the receiver unit positioned at the access to the parking lot or the parking garage, causing the access barrier blocking the parking lot or the parking garage to open automatically. As a consequence, time-consuming actions by the automobile driver such as driving up to the barrier and stopping the vehicle, rolling down the window, and introducing an identification card into a read-out unit are advantageously completely eliminated.

Obviously, the method described in the invention can be used not only for entry into a secured access area, but also for exiting the same area. Following the parking garage example, this would mean that an automobile driver wishing to leave the parking garage or the parking lot would drive up to the exit barrier, which would open automatically as soon as the radio module carried by the driver reaches the area around the receiver unit positioned at the exit.

A further advantage of the method described in the invention is the possibility of a cost-effective and easily implemented retrofitting of already existing opening and closing systems. In this process, it is necessary only to position the receiver units needed to implement the method in the access area and in the exit area, and to connect them with the communication system of the already existing opening and closing system. Further, each authorized person or each authorized object must be provided with a radio module, wherein, in accordance with a special refinement of the invention that will be described in detail further below, mobile telephones already possessed by the user can be used as radio modules, thus the additional acquisition and furnishing of a separate radio module can be dispensed with. Consequently, with respect to retrofitting the method described in the invention, it is necessary only to position receiver units in the area of the entrance and exit, which makes retrofitting very cost-effective.

With a retrofitting of the method described in the invention, it is not necessary to shut off the existing system or to eliminate it without replacement. Rather it is possible to operate an already existing system in parallel with the method described in the invention, so that access authorization can be conducted in accordance with the method of the invention and the existing method. Such a combination of existing and new methods offers is especially advantageous when different groupings of persons and/or objects have access to a secured access are. Thus, for example, the group of one-time parkers can be distinguished from the group of long-term or regular parkers in parking lots or parking garages. With a combination of the new method and a method already installed in a parking lot or in a parking garage, one-time parkers can be guaranteed access through the already existing system, while long-term or regular parkers are offered simplified access via the method of the invention.

A further feature of the invention provides that, following the successful identification of a person and/or an object, additional information is transferred from the information unit to the radio module. For example, additional information regarding the secured access area can be provided, offering support to one seeking access. With respect to a parking lot or a parking garage, such additional information may, for example, concern the current parking situation in the parking lot or the parking garage, so that a person driving into the parking garage can be informed as to places in the parking garage or parking lot where free parking spaces may be found. Further information in this connection may, for example, include local information concerning parking spaces for the handicapped, parking spaces for expectant mothers, and exits. In this, the transmission of additional information would preferably take place only at the request of the person and/or object, so that a transmission of information would take place only when it is desired.

A further feature of the invention provides that the short-range radio is implemented between the radio module and the receiver unit and/or transmission unit via the Bluetooth standard. The advantage of using Bluetooth technology consists in the capacity of the radio module to set up a connection to the receiver unit very rapidly, wherein the radio signals are capable of penetrating materials such as clothing, pockets, glass, etc., and it is not necessary to establish visual contact between the radio module and the receiver unit. Furthermore, it is advantageous for a radio module based upon Bluetooth technology to be provided with a Bluetooth identification number, which is definite and unique and can be adduced as an identification signal within the framework of the method of the invention.

Advantageously, already existing technical apparatus that are equipped with radio modules based upon Bluetooth technology can be used as radio modules for the method specified in the invention. For example, apparatus such as mobile telephones, palm pilots, laptops, etc. should be mentioned in this connection.

For a successful implementation of the method of the invention, it is necessary only for the Bluetooth identification number of the technical apparatus already in possession of a user or an operator, for example a mobile telephone, to be ascertained and stored as an identification signal in the central information unit. As soon as the user, with his/her mobile telephone serving as a radio module, enters the area around a receiver unit installed in accordance with the method of the invention, the corresponding door or the corresponding barrier of a parking lot or a parking garage opens. As an alternative to this, a Bluetooth technology-based radio module intended specifically for allowing access to the secured access area may be provided. This would have the advantage that the radio module could be permanently positioned as an invisible door or barrier opener in a place provided for it. For example, it could be advantageous to place such a radio module permanently in the glove compartment of an automobile, so that the vehicle could enter parking lots or parking garages that had enabled the use of the method of the invention, independently of the owner or driver of the motor vehicle.

Furthermore, it can be advantageously provided that an allocation of more detailed information concerning the person or object identified can be implemented via identification using the method specified in the invention. For example, in this connection a rebate and rate system is conceivable. For example, it can be provided that with the automatic recognition of entry and exiting a parking garage or a parking lot, parking time is computed, a previously agreed-upon rate is allocated, and a resulting parking fee is calculated. In this case, automatic billing can take place at regular intervals.

With respect to the device, to attain the object upon which the invention is based a device for implementing the method is proposed, which is characterized by a receiver unit and a radio module that is movable relative to this receiver unit, wherein the receiver unit and the radio module are connected with regard to communications technology via short-range radio.

Advantageously, the device specified in the invention consists of only two structural components, namely the receiver unit on the one hand and the radio module on the other. The receiver unit is stationary. The radio module is carried by the user as a separate component and is consequently mobile relative to the receiver unit. If the user wishes to contact the information unit, he/she merely needs operate his/her radio module. The radio module transmits a corresponding identification signal or inquiry signal to the receiver unit. This unit transmits the received signals to the information unit, which processes the incident signals and generates a corresponding output signal.

According to one special refinement of the invention, a device for implementing the method, especially for identifying a person and/or an object for access into a secured access area, is proposed, which is characterized in that a stationary receiver unit is positioned in the region of access to the secured access area, and is connected to an information unit via communications technology.

The receiver unit, when using Bluetooth technology a so-called access point, is positioned in the area of the entrance as well as electively in the area of the exit for installation of the device of the invention. A communication connection is then produced between the receiver unit and the existing communication structure. Should the latter not yet be present, a corresponding structure is to be created. Once the connection to the central computer, i.e. the information unit, is established, the device of the invention is ready for use.

In accordance with a further feature of the invention, a transmission unit that is connected via communications technology to the central computer unit is provided at the entrance area and electively at the exit area. The transmission unit serves to transmit additional information from the central information unit that may provide additional support to the one seeking access.

It is further provided in accordance with the invention that the radio module comprises a transmitter as well as a receiver. In this manner, it is assured that the radio module not only emits corresponding radio signals for recognition by the receiver unit, but can also receive signals from any transmitter unit provided. To display reports received, the radio module is advantageously equipped with a communication unit, preferably a display, which displays the additional information transmitted by the central information unit.

In accordance with a further characterizing feature of the device, the communications technological connection between receiver unit and/or the transmitting unit on the one hand and the central information unit on the other hand is a LAN or a fixed network. This type of communications connection is distinguished by its reliability and its rapidity, and is therefore advantageously usable in connection with the method of the invention.

In accordance with a further characterizing feature of the device specified in the invention, the radio module is a radio module based upon the Bluetooth standard. The advantages resulting from this, especially with respect to the use of already existing devices as radio modules, such as Bluetooth-enabled mobile telephones or laptops, have already been explained in connection with the method of the invention.

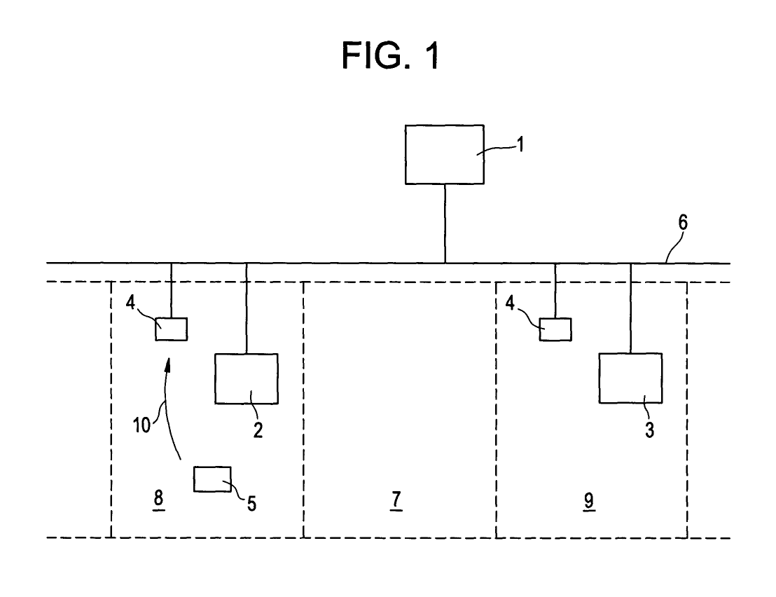

Further advantages and characterizing features of the invention emerge from the description on the basis of FIG. 1, which illustrates in schematic representation the application of the method of the invention in a parking garage as a secured access area.

A secured access area 7 is schematically represented in FIG. 1, such as would be found, for example, in a restricted parking garage. The secured access area 7 borders an entrance area 8 and an exit area 9. In order to enter the parking garage, i.e., to enter the secured access area 7, it is necessary to pass through the entrance area 8. Exiting the area 7 necessarily takes place via the exit area 9.

An entry card-reading device 2 for corresponding cards provided with a magnetic strip is provided in the entrance 8 area. A corresponding read-out device, an exit card-reading device 3, is provided in the exit area 9. The entry card-reading device 2 and the exit card-reading device 3 are connected to a central information unit 1 via a communications connection 6.

In order to gain access to the secured access area 7, a corresponding card must be inserted into the entry card-reading device 2, or a corresponding card must be removed. Once this takes place, the barrier blocking the access is opened and the vehicle is allowed to enter the area 7. When driving out of the area 7, the card must be inserted into the exit card-reading device 3 to open the barrier in the exit area 9.

Further, a receiving and a transmission unit 4 are provided in both the entrance area 8 and in the exit area 9. These are hooked up to the communication connection 6.

Advantageously, a LAN network is provided for communication with the central information unit 1, and the receiving and transmission units 4 are designed as so-called Bluetooth-LAN access points, which consequently operate the receiver-transmitter pair using Bluetooth technology.

A radio module 5 in the entrance area 8 is represented by way of example in FIG. 1. A mobile telephone, for example, can be used as the radio module 5. This radio module 5 communicates with the receiver-transmitter pair 4. This communication is indicated by the arrow 10.

As an alternative to the above-described use of the entrance card- and exit card-reading devices 2 and 3, the barriers blocking the entrance area 7 can also be opened or closed via the radio module 5. Once the radio module 5 enters the entrance area 8 and consequently enters into communication range with the receiver and transmitter unit 4, an identification signal is transmitted to the receiver and transmitter unit. With the use of Bluetooth technology, this identification signal is preferably a Bluetooth identification code, which is both unique and unambiguous. The Bluetooth identification code serves as an authorization code and is sent via the communication connection 6 to the central information unit 1. There, a comparative examination against a previously stored identification takes place. If identity exists, the central information unit 1 issues the signal to open the barrier. Otherwise, the barrier remains closed.

The above-described operation steps are implemented in the same manner when the secured access area 7 is to be exited through the exit area 9.

The above-described embodiment serves merely to explain the invention in greater detail and in no case operates restrictively.

### REFERENCE NUMBER LIST

1 Information unit
2 Entrance card-reading device
3 Exit card-reading device
4 Receiver and transmitter unit
5 Radio module
6 Communication connection
7 Secured access area
8 Entrance area
9 Exit area
10 Arrow

1. Method for exchanging information between a central information unit on the one hand and a person and/or an object on the other, the method comprising: transmitting an identification signal via short-range radio from a radio module to a receiver unit and from thence to the information unit, wherein the information unit processes the identification signal and generates an output signal which is then transmitted to a corresponding output unit.

2. Method according to claim 1, wherein further comprising transmitting an inquiry signal from the radio module to the receiver unit, and is transferred to the information unit.

3. Method according to claim 2, wherein the information unit processes the identification signal and the inquiry signal and generates an output signal which is then transferred to a corresponding output unit.

4. Method according to claim 1, wherein the output signal is issued by a transmitter unit as the output unit, wherein a corresponding signal is transmitted to the radio module.

5. Method according to claim 1, wherein the output signal is issued via a signal processing apparatus as an output unit.

6. Method according to claim 1, wherein the identification signal is automatically transmitted from the radio module to the receiver unit as soon as the radio module is located in the area of the receiver unit.

7. Method for exchanging information for identifying a person and/or an object for access into a secured access area, the method comprising: transmitting an identification signal via short-range radio from a radio module to a stationary receiver unit positioned in the entrance areas, and to the information unit, wherein the information unit checks the transmitted identification signal and upon successful examination approves access.

8. Method according to claim 7, wherein an examination of the transmitted identification signal is implemented in a comparison test between an identification previously stored by the information unit and the transmitted identification signal, wherein access is approved based upon the identity of the transmitted identification signal and the stored identification.

9. Method according to claim 7, wherein the information unit checks the transmitted identification signal and upon successful examination approves a person and/or object to leaves the secured access area.

10. Method according to claim 7, wherein, following a successful identification of the person and/or object, additional information is transferred from the information unit to the radio module.

11. Method according to claim 10, wherein the transmission of additional information takes place only at the request of the person and/or object.

12. Method according to claim 7, wherein the short-range radio between the radio module and the receiver unit and/or the transmitter unit is implemented via Bluetooth standard.

13. Device for implementing a method for exchanging information, the device comprising:
a receiver unit and a radio module that is movable relative to this receiver unit, wherein the receiver unit and the radio module are connected to one another in terms of communications technology via short-range radio;
means for transmitting an identification signal via short-range radio from the radio module to the receiver unit and from thence to an information unit, and
the information unit processes the identification signal and generates an output signal which is then transmitted to a corresponding output unit.

14. Device according to claim 13, wherein the receiver unit is connected to the information unit in terms of communications technology, wherein the communication connection is a LAN network and/or a fixed network.

15. Device according to claim 13, wherein the radio module is a Bluetooth radio module.

16. Device according to claim 13, characterized in that a transmitter unit and/or a signal processing apparatus is provided as the output unit.

17. Device for implementing a method for indentifying a person and/or object for access into a secured area the device comprising:
a stationary receiver unit is provided in an area of the entrance to the secured access area which is connected to an information unit via communications technology;
means for transmitting an identification signal via short-range radio from a radio module to the stationary receiver unit positioned in the entrance area, and to the information unit, and
the information unit checks the transmitted identification signal and upon successful examination approves access.

18. Device according to claim 17, wherein a stationary receiver unit is provided in the exit area for the secured access area which is connected via communications technology to a central information unit.

19. Device according to claim 17, wherein a transmitter unit connected to the information unit via communications technology, is provided in the entrance area and electively also in the exit area.

20. Device according to claim 17, wherein the radio module comprises both a transmitter and a receiver.

21. Device according to claim 17, wherein the communications technological connection between the receiver unit and/or the transmitter unit on the one hand and the central computer unit on the other is a LAN network or a fixed network.

22. Device according to claim 17, wherein the radio module is a radio module based upon the Bluetooth standard.

23. Device according to claim 17, wherein the radio module is a separate, transportable radio module.

24. Device according to claim 17, wherein the radio module is connected to a communications unit, preferably a display, which displays additional information transferred by the information unit.

25. Device according to claim 17, wherein the receiver unit and the transmitter unit are combined and form a Bluetooth-LAN access point.

26. Device according to claim 17, wherein the secured access area is a parking garage or a parking lot.

27. Method according to claim 1, wherein the short-range radio between the radio module and the receiver unit and/or the transmitter unit is implemented via Bluetooth standard.
